(19) United States
(12) Patent Application Publication
(10) Pub. No.: US 2004/0170759 A1
(43) Pub. Date: Sep. 2, 2004

(54) Apparatus and method for applying dry colorant to wood particulate material

(76) Inventors: Gary M. Bardos, Remus, MI (US); Larry C. Burkholder, Bradenton, FL (US)

Correspondence Address: John D. Wright, Reising, Ethington, Barnes, Kisselle & Learman, PC, 5291 Colony Drive North, Saginaw, MI, 48603, US

(21) Appl. No.: 10/728,167

(22) Filed: Dec. 4, 2003

Related U.S. Application Data
(60) Provisional application No. 60/450,730, filed on Feb. 28, 2003.

(51) Int. Cl. B05D 1/12; B05D 7/00

(52) U.S. Cl. 427/212; 427/180

(57) ABSTRACT

An apparatus, method of producing, method of operation and method of construction for producing a decoratively colored finish ground wood material includes providing a hopper adjacent a conveyor mechanism for maintaining and dispensing dry colorant onto a primary ground wood material. Further, providing and arranging a liquid dispensing mechanism adjacent an opening of a receptacle of a communition apparatus and dispensing liquid to wet the coated primary ground wood material. Lastly, grinding the wetted primary ground wood material with the comminution apparatus into a finish ground material of a lesser size than the primary ground wood material.

### REFERENCE TO CO-PENDING APPLICATION

This application claims the benefit of U.S. Provisional Patent Application Serial No. 60/450,730, filed on Feb. 28, 2003.

### BACKGROUND OF THE INVENTION

It is known in the art to prepare ground wood product chips from spent wood pallets, wood debris, or the like which have been colored by application of a liquid-borne dye for use as landscape mulch, and the like.

In all known processes and equipment for coloring wood chips, the liquid dye is applied either to the finished ground wood chips as they are augered along a screw conveyor into a pile, as disclosed in U.S. Pat. No. 5,358,738, or another approach is to add both dry colorant and water combinatively into the grinding stage of a tub enclosed hammer mill or like mechanism during which the chips are colored. Finally, another known approach is to add dry colorant to a pile of ground wood chips and then to mix them together manually, such as by repeatedly scooping and dumping the material with a front end loader, a pitchfork, or the like, after which the material is introduced to a secondary grinding operation.

Many of these known techniques have difficulty producing a final end product with consistent, uniform color, having no good way of metering the colorant and thus applying too much, too little or inconsistent distribution of coloring throughout a batch. Some of these processes apply dry colorant in an open air atmosphere such that the colorant is prone to being blown away by the wind. Another disadvantage is that if the dry colorant is added during or after the final grind, there may be insufficient time allotted or means for thoroughly mixing the end product material and the dry colorant for an even distribution throughout. Consequently, even if such surfaces are colored, they may be only lightly covered and may not have a uniform appearance with the rest of the product surfaces and will be prone to fading or discoloring non-uniformly with respect to the rest of the surface of the product. Likewise, applying the liquid coloring during a primary grind stage could result in subsequent uncolored or non-uniform colored surfaces of the product which are exposed in secondary grinding operations, leading to non-uniform, inconsistent product.

It is an object of the present invention to overcome or greatly minimize the foregoing disadvantages of the known prior art.

### SUMMARY OF THE INVENTION

This invention is directed to methods of constructing a system used for producing colored wood chip material and to methods for coloring ground wood chip material. One method of constructing a comminution and coloring system having a dry colorant application system and being capable of grinding or chipping wood material to produce a decoratively colored finish ground material provides a container for maintaining dry colorant particles, with an opening in the container for dispensing the dry colorant particles onto a primary ground wood material of an initial size as the chips exit a grinder or chipper. The method includes maintaining the container adjacent an outlet conveyor mechanism of the communition apparatus to provide for disbursement of dry colorant particles from the container onto the primary ground wood material transferring along the outlet conveyor mechanism. Further, the method includes providing a liquid dispenser or a spigot adjacent a receptacle of communition apparatus functioning as a secondary grinder and dispensing water through the spigot into the receptacle at a controlled rate to wet the primary ground wood material that has been uniformly coated with dry colorant particulate. The wetted primary ground wood material is then further ground into a finish ground chip material of a lesser size than the primary ground wood material during which steps the dry colorant particulate is impregnated within the finish ground wood chip material, thereby altering the visual appearance of the primary ground wood material to take on the desired decorative color.

Another aspect of the invention includes providing a method for producing a decoratively colored finish ground wood material utilizing a comminution apparatus. The method includes providing a primary ground wood chip material of an initial size and conveying the primary ground wood chip material along a path. Further, the method comprises dispensing dry colorant particulate substantially uniformly onto the primary ground wood chip material as it is being conveyed. Next, it involves transferring the primary ground wood chip material with dry colorant particulate disbursed thereon into the receptacle of a comminution apparatus. Next, water is sprayed onto the primary ground wood chip material with dry colorant particulate dispersed thereon. Finally, the wetted primary ground wood chip material with colorant particulate thereon is further size reduced to impregnate the dry colorant uniformly within the ground wood chip material to produce the decoratively colored finish ground wood chip material of lesser size desired.

One advantage of the invention is that it provides a method and apparatus for producing a uniformly colored finish ground wood chip material.

Another advantage of the invention is that the method and apparatus produce a colored ground chip material that resists fading.

Another advantage of the invention is that the method and apparatus minimize dry colorant particulate waste during the manufacture of the colored ground wood chip material.

Another advantage of the invention provides a method and apparatus for producing a uniformly colored ground wood chip material at a variable production rate.

Another advantage of the invention provides a system allowing an operator to control and meter the dry colorant particle disbursement rate and the water disbursement rate to produce a uniformly colored ground wood chip material.

Another advantage of the invention provides a dry colorant system that is adaptable to a variety of standard comminution machines.

Another advantage of the invention provides a comminution apparatus that can be operated with or without operation of a dry colorant system.

Another advantage of the invention provides a method and apparatus permitting utilization of a single comminution apparatus to produce a colored ground wood chip material.

Another advantage of the invention provides a relatively simple and economical method and apparatus for producing colored ground wood chip material.

It should be recognized that one ordinarily skilled in the art will recognize other advantages of this invention by viewing the complete disclosure herein, and that the above represents only a partial listing of advantages provided by this invention.

### THE DRAWINGS

The presently preferred embodiment is disclosed in the following description and in the accompanying drawings, wherein:

FIG. 1 is a partial perspective view of a comminution apparatus having a colorant system constructed according to one presently preferred embodiment of the invention;

FIG. 2 is a partially broken away side elevation view of the comminution apparatus of FIG. 1;

FIG. 3 is a partial plan view looking in the direction of arrow 3 of FIG. 2;

FIG. 4 is an exploded perspective view showing a dry colorant hopper of the apparatus of FIG. 1;

FIG. 5 is an assembled perspective view of the dry colorant hopper with a cover in an open position;

FIG. 6 is an enlarged fragmentary perspective view showing a portion of a control mechanism of the colorant system;

FIG. 7 is a fragmentary perspective view of a conveying system of the colorant system;

FIG. 8 is a fragmentary perspective bottom view of a portion of the colorant system;

FIG. 9 is a schematic diagram illustrating another embodiment of the presently preferred method for producing a colored ground wood chip material; and

FIG. 10 is a flow chart illustrating a control system for producing the colored ground wood material.

### DETAILED DESCRIPTION

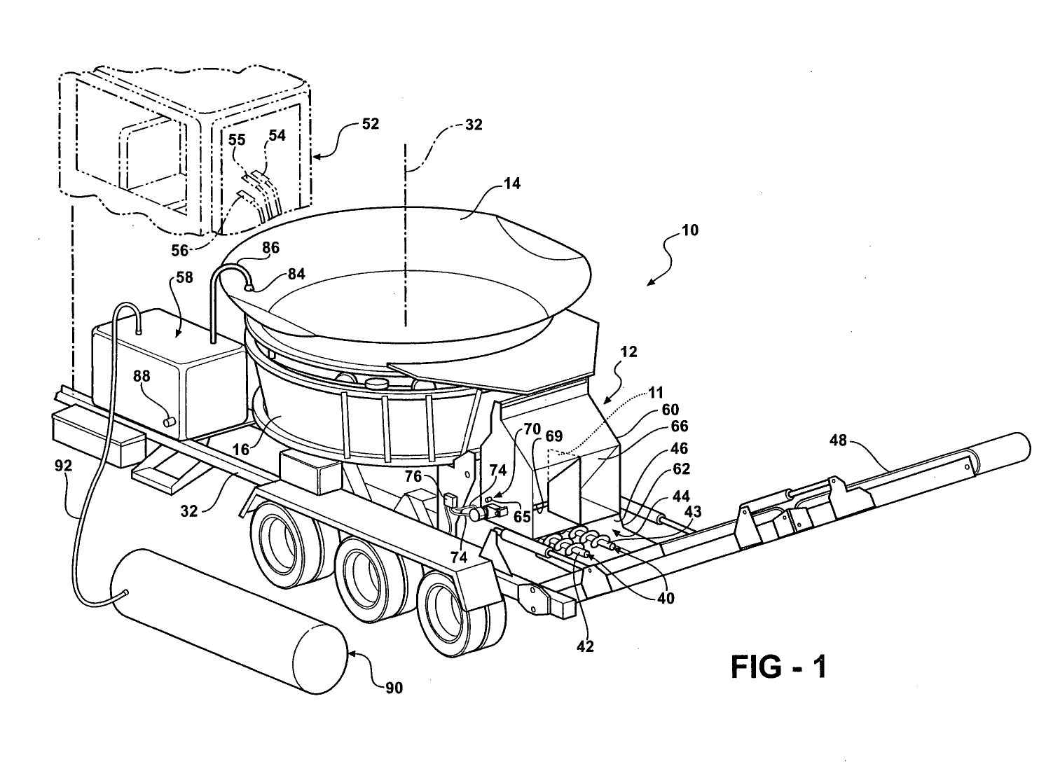

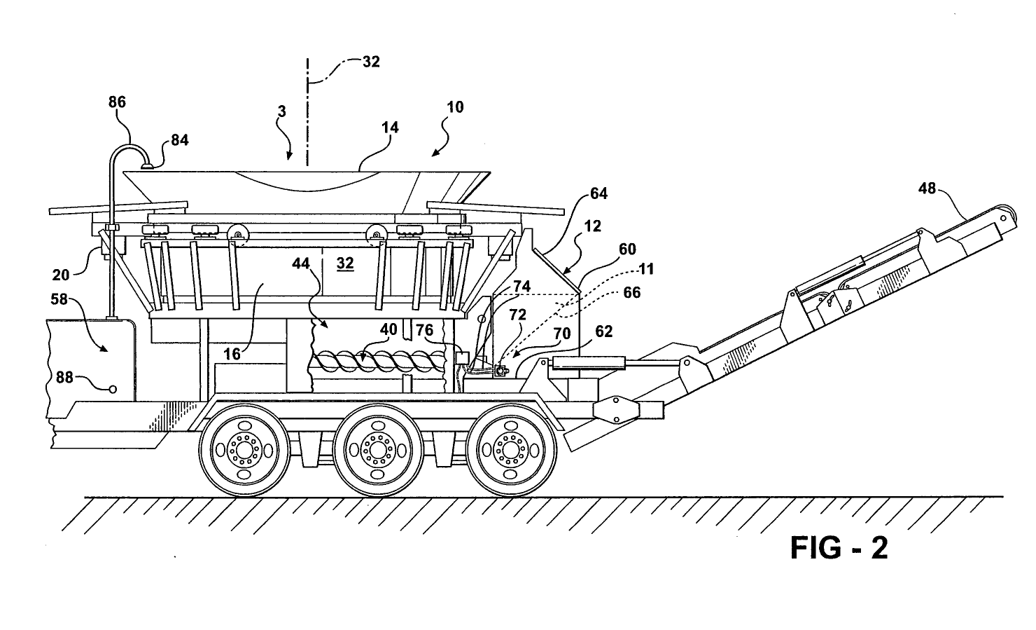

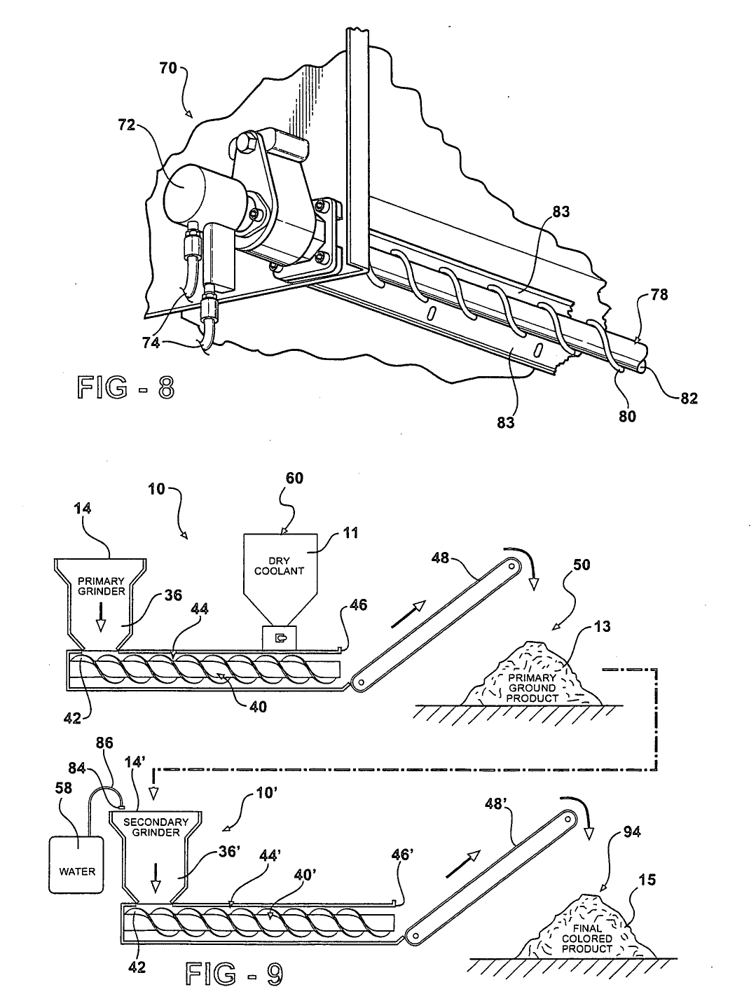

FIGS. 1 and 2 illustrate a comminution apparatus, for example, and without limitation, a tub grinder 10 incorporating a dry colorant system 12 for applying a dry colorant particulate, referred to as dry colorant 11 hereafter, to a primary ground wood material 13 (FIG. 9), which may be wood chips ground from spent wood pallets, wood chip products or debris, or the like. The ultimate object is to produce a uniformly colored wood chip material 15 (FIG. 9) using either a secondary reducing grinder, represented here as a tub grinder 10′ or returning the primary ground wood chip material 13 to the tub grinder 10 for a secondary grind to produce the finish ground wood chip material 15 which is lesser in size than the primary ground wood chip material 13. It should be understood that the invention contemplates the use of a variety of types of wood grinders, other than tub grinders, such as but not limited to horizontal feed wood grinders, gravity feed wood grinders, and the like, incorporated herein by reference.

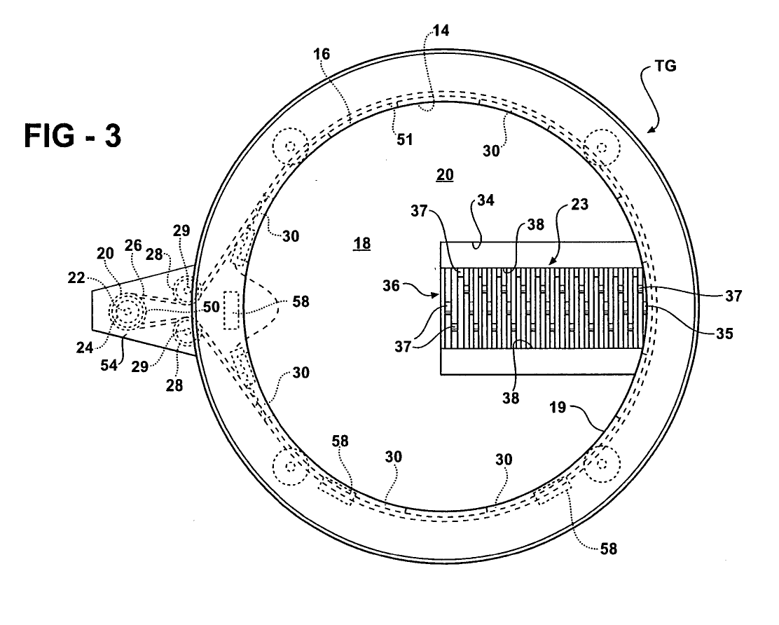

The tub grinder 10 which may be of the construction shown in Morbark's U.S. Pat. No. 5,419,502 issued May 30, 1995 which is incorporated herein by reference, has a tub or chamber 14 in which an operator places wood material, such as scrap wood pallets, wood debris or the like, for grinding the material into the primary ground wood material 13. The chamber 14 has an outer cylindrical wall 16 arranged for rotation relative to a base 18 (FIG. 3). Still referring to FIG. 3, the rotating wall 16 may be suitably driven by a rotary hydraulic motor 20 which may be driven by a pump driven by a diesel engine, or could be mechanically coupled to the diesel engine (not shown). An output shaft 22 of the motor 20 mounts a sprocket 24 which, via a chain 26 revolves a pair of idler sprockets 28 on idler shafts 29. As the motor 20 operates to rotate the sprocket 24, the chain 26 engages a series of arcuate racks 30 fixed around the circumference of the wall 16. Accordingly, the wall 16 is caused to rotate relative to the generally fixed base 18 about a central axis 32 of the wall 16.

Still referring to FIG. 3, the base 18 of the tub 10 has an opening 34 wherein a hammer mill 36 is supported by an elongate shaft 35 within a housing (not shown) for rotation with the shaft 35. As the hammer mill 36 rotates, a plurality of hammers 37 attached to the hammer mill 36 forcefully engage the wood material rotating about the axis 32 in the chamber 14 to cut or grind the material against an anvil 38 typically supported by the base 18 adjacent at least one side of the opening 34. As shown in FIGS. 1, 2, 7 and 9, upon the material being chipped or ground, the material is discharged from the tub 10 into a bottom feed auger-type screw conveyor 40, represented here as a pair of rotating augers 42, 43 driven preferably hydraulically in opposite directions in a material channel or trough 44.

As shown in FIG. 9, upon initially grinding the raw wood material into the primary ground wood material 13, typically the wood chip material 13 is between three inches by five inches (3″×5″) to four inches by six inches (4″×6″) in size. The primary ground wood material 13 is transferred by the augers 42, 43 along the trough 44 from beneath the opening 34 toward an outlet or discharge end 46 (FIG. 1) where the primary ground wood material 13 is discharged onto a belt conveyor 48. The belt conveyor 48 carries the primary ground wood material 13 upwardly and then discharges the material from the conveyor 48 into a storage pile 50, as desired.

The apparatus 10 described may be of the type manufactured by the assignee of the present invention, such as the Morbark 1300 Tub Grinder available from Morbark, Inc. of Winn, Mich. Other primary grinders that may be used includes the Morbark 4600 Wood Hog, and Morbark 1300 HMV also available from Morbark, Inc. It should be understood that the above grinders may also be used for a secondary grind operation with a screen change to provide a mesh with smaller openings to produce the final ground wood chip material 15, as discussed in more detail hereafter. It should also be recognized that the screw-type augers 42, 43 are presently preferred, but other conveying mechanisms may be used to convey and mix the primary ground wood material 13 and the dry colorant 11, such as belt conveyers for example, and the like.

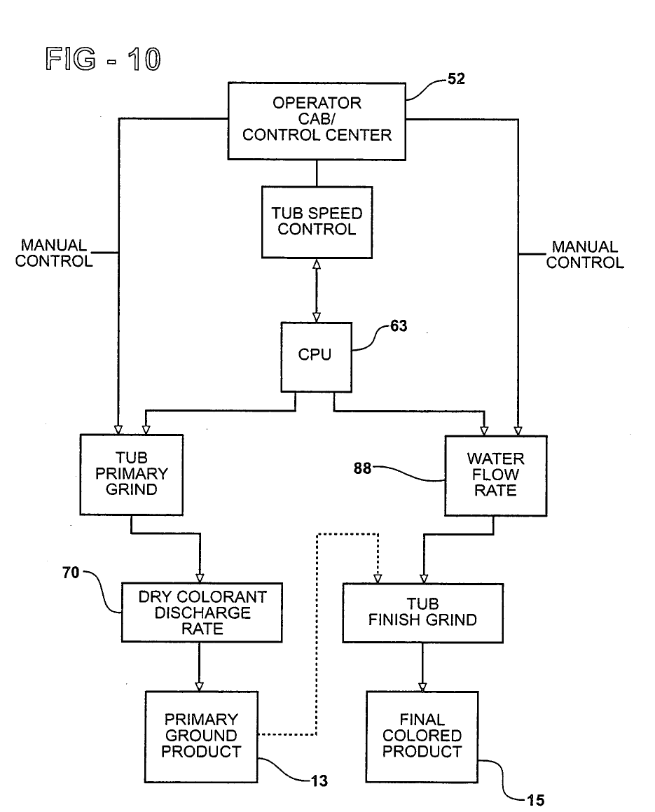

As shown in FIG. 1, it should be understood that the apparatus 10 may incorporate an operator's cab 52, wherein an operator may remotely control the function of the individual mechanisms operably attached to the apparatus 10. Preferably, the cab 52 has a plurality of actuatable switches or levers, wherein at least one lever 54 operably communicates with the chamber 14 to control the rate or angular velocity at which the chamber 14 rotates relative to the base 18. When the tub grinder 10 is to function also as the secondary grinder, another lever 55 is preferably incorporated and operably communicates with a primary vessel 58 to control the flow rate at which water is discharged from the vessel 58 (discussed il more detail hereafter). Yet another lever 56 is preferably incorporated to operably communicate with dry colorant containing container or hopper 60 to control the discharge rate of the dry colorant 11 from the hopper 60 (discussed in more detail hereafter). It should be understood that the levers 54, 55, 56 may be used to manually control their respective functions independently of one another, or their respective functions may be communicated through a central processing unit (CPU) 63 so that the functions are automatically adjusted relative to one another (FIG. 10), generally dependant upon the rate at which the chamber 14 rotates. It should also be understood that the levers 54, 55, 56 communicate with the chamber 14, the primary vessel 58 and the hopper 60, respectively, through any suitable control mechanism, such as for example, hydraulic controls, pneumatic controls, radio frequency controls, electromechanical controls, and the like.

Upon the raw wood material being ground into the primary ground wood material 13, the primary ground wood material 13 falls through the opening 34 of the chamber 14, through a set of grates having openings of a desired size (not shown) and onto the augers 42, 43. The primary ground wood material 13 travels along the trough 44 and generally beneath the hopper 60 where the dry colorant 11 is discharged at a controlled rate onto the primary ground wood material 13 by the dry colorant system 12.

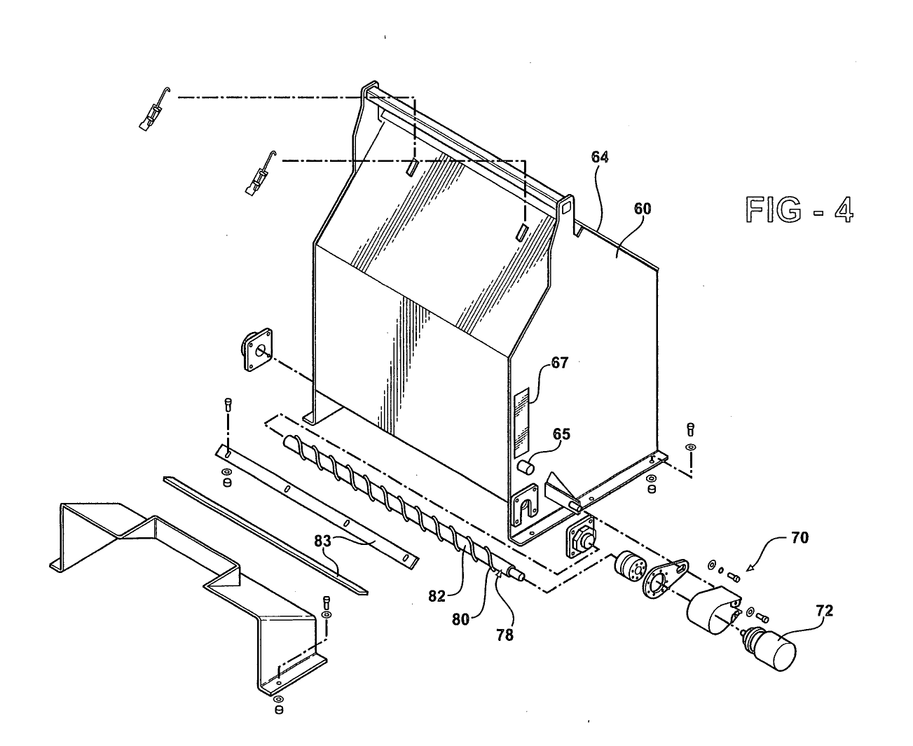

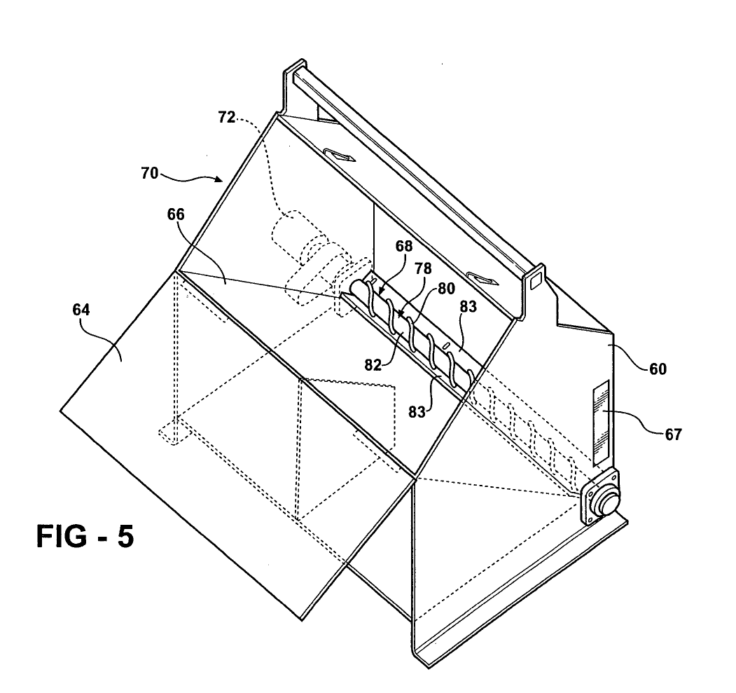

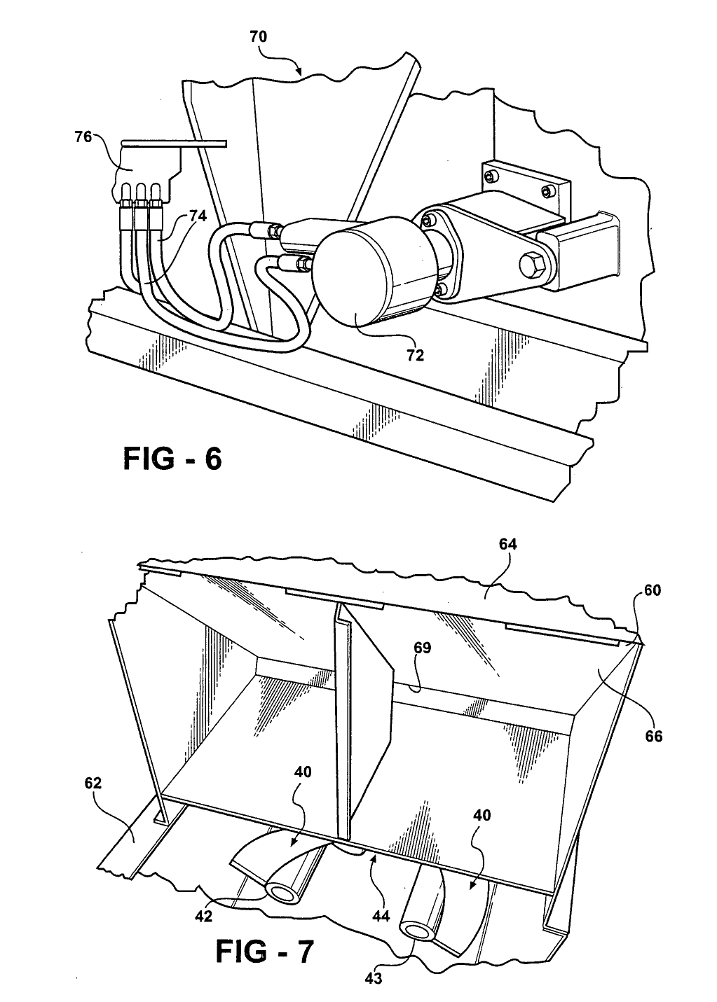

The dry colorant system 12 communicating with the apparatus 10 is operative to apply the dry colorant 11, for example and without limitation, red, black or green in color, to the primary ground wood material 13 before any secondary grinding operations are performed on the primary ground wood material 13. The system 12 preferably has the hopper 60 mounted on a support frame 62 (FIG. 7) in a position generally over the conveyor 40 or augers 42, 43. As best shown in FIGS. 4 and 5, the hopper 60 preferably has a hinged lid 64 which, when opened, allows the dry colorant 11 to be charged into the hopper 60. The hopper 60 preferably has a tilted or slanted floor 66 which gravitationally directs the colorant 11 toward an opening 68 in a bottom surface 69 of the hopper 60.

As best shown in FIGS. 4, 6 and 8, to control the discharge rate of the dry colorant from the hopper 60 onto the primary ground wood material 13, the hopper 60 is generally equipped with a metering system 70. As best shown in FIG. 6, preferably the metering system 70 is driven by a hydraulic motor 72 that is coupled by hoses 74 to a hydraulic control system 76.

As best shown in FIGS. 4, 5 and 8, the metering system 70 communicates with an auger 78 operably connected to the hydraulic motor 72. The auger 78 is rotatably received along the length of the opening 68 in the hopper 60. The auger 78 may be constructed in any suitable manner, and is shown here having a bead 80 of material bonded to a generally cylindrical length of rod material 82, wherein the bead 80 is in a generally helical configuration. In addition, at least one,. and shown here as a pair of compliant seals 83, preferably constructed from a rubber or plastic material, are attached adjacent the opening 68 of the hopper 60 and generally engage the auger 78 to facilitate regulating the discharge rate of the dry colorant 11 from the hopper 60. The metering system 70 controls the rate of feed of dry colorant 11 in accordance with the speed of augers 42, 43 and the quantity of primary ground wood material 13 traveling along the conveyor 40 in order to produce an optimal coverage of dry colorant 11 on the primary ground wood material 13 and to reduce waste of the dry colorant 11. Preferably, as shown schematically in FIG. 10, the discharge rate of dry colorant 11 from the hopper 60 is automatically adjusted by the CPU 63 or may be manually set by the operator via lever 56. Desirably, the CPU 63 adjusts the discharge rate of dry colorant 11 to coincide with the rate of rotation of the chamber 14 and speed of rotation of augers 42 and 43. Additionally, upon the level of dry colorant 11 within the hopper 60 reaching a low level condition, preferably, a sensor 65 operates to send a signal to the operator in the cab 52. Desirably, the sensor 65 illuminates a light, or rings an alarm (not shown) within the cab 52. It should be recognized that other mechanisms may be used to indicate to the operator that a low dry colorant level condition exists within the hopper 60, such as, for example and without limitation, a window 67 (FIGS. 4 and 5). The window 67 allows the operator to view inside the hopper 60 to readily see the dry colorant 11 in the hopper. As such, when the level of dry colorant 11 within the hopper reaches a low level condition, the operator may visually see the low level condition.

Upon having dry colorant 11 discharged onto the primary ground wood material 13, the material 13 travels along the trough 44 where the augers 42, 43 operate not only to distribute the dry colorant 11 uniformly over the outer surfaces of the primary ground wood material 13, but also to impregnate the dry colorant 11 into the primary ground wood material 13, thereby reducing the possibility of the dry colorant 11 not adhering to the primary ground wood material 13.

Upon churning and blending the dry colorant 11 with the primary ground wood material 13 via the augers 42, 43, the material 13 is preferably discharged onto the belt conveyor 48, where the material 13 is preferably conveyed to a storage pile 50. Once the primary ground wood material 13 having dry colorant 11 uniformly distributed thereon is in the storage pile 50, the material 13 may be stored for several hours or days before further processing, or it may be immediately fed directly in line to a secondary grind process, discussed in more detail hereafter. It should be recognized that the primary ground wood material 13 with dry colorant 11 uniformly distributed thereon may be routed back into the chamber 14 of the same comminution apparatus 10 that produced the primary ground wood material 13. In this case, only one apparatus 10 is required to produce the finished and colored ground wood material 15. The supply of dry colorant 11 is first deactivated and the water supply to the tub 14 is activated to spray a predetermined volume of water upon the revolving mass of first stage chips returned to the same tub grinder 10. The tub grinder 10 may be operated at an increased speed and may have replaced screens with a reduced mesh size (not shown) beneath the hammer mill 36. New surfaces will be cut in this reducing action which have not been coated with dry colorant.

The water is maintained in the vessel 58 and communicated to the primary ground wood material 13 in the chamber 14 via a hose or conduit 86. Desirably, the conduit 86 is coupled to an outlet or spigot 84 to facilitate dispensing the water uniformly on the primary ground wood material 13. As shown in FIGS. I and 2, the vessel 58 can be attached to the frame of the comminution apparatus 10 so that water supply can be transported along with the comminution apparatus 10. Otherwise, it should be recognized that a secondary vessel 90, or other source of water supply, such as, for example and without limitation, a well, containing water may be operably connected to the apparatus 10 via a secondary conduit 92 either connected to the vessel 58, as shown, or directly to the spigot 84, not shown.

As shown in FIGS. 1 and 2 wherein the coarse grinder or tub grinder 10 is also used as the reducing grinder or secondary grinder and like numerals are used to designate the water supplying elements, the water flow rate from the spigot 84 is desirably regulated by a water metering device 88 operably communicating with the chamber 14. The water metering device 88 may be in communication with the CPU 63 so that the CPU 63 can regulate the discharge rate of water from the spigot 84 in proportion to the rate at which the chamber 14 rotates or may be manually controlled by the operator directly or remotely so that lever 55 will control the flow rate according to the speed of the chipper. As such, an optimal amount of water can be dispensed onto the material 13 to obtain an optimal mix of water and colorant bearing primary ground wood material 13.

Desirably, the water metering device 88 is also able to detect the water level within the vessel 58. As such, when the water level in the vessel 58 reaches a low level condition, a signal can be sent to the operator in the cab 52. Desirably, the signal illuminates a light or rings an alarm (not shown) in the cab 52. As best illustrated in FIG. 10, it should be understood that the operator within the operator's cab 52 can either control the rate at which the chamber 14 rotates, thereby automatically controlling the rate at which water discharges from the valved spigot 84 via the CPU 63 controlling the positions of the spigot valve, or the operator may manually override the water metering device 88 and the CPU 63 to have the water discharge from the spigot 84 at some other desired rate or closed off.

Once the supply of primary ground wood material 13 having dry colorant 11 uniformly distributed thereon is combined with the water in the chamber 14, and upon being reduced to the final ground wood material 15, the final ground wood material 15 is further churned by the augers 42, 43. As such, the dry colorant 11 is further impregnated within the final ground wood material 15, thereby further improving and enhancing the useful life of the final product 15. The finished ground wood material 15 is carried to a secondary belt conveyor 48′ where the final ground wood material 15 may be discharged to a final storage pile.

Referring now to FIG. 9 wherein an alternative reducing grinder or secondary grinder is used, the primary ground wood material 13 having been uniformly coated with dry colorant 11 may be charged to a secondary comminuting apparatus, which as mentioned, may be another tub grinder 10′ (FIG. 9) of the same construction as in the primary grind process described. Upon charging a chamber 14′ with the primary ground wood material 13 having the dry colorant 11 uniformly covering and impregnating its exposed surfaces, the material 13 is reground in a secondary hammer mill 36′ with an adjacent finer mesh screen than in tub grinder 10. Prior to regrinding the primary ground wood material 13 into the finish ground chip material 15, typically having a reduced chip size approximately three inches by five inches (3″×5″), and more typically on the order of about two inches by three inches (2″×3″), water is introduced into the chamber 14′ to at least partially wet the primary ground wood material 13.

The final ground wood material 15 having colorant 11 uniformly impregnated in all its surfaces may either be packaged immediately, or remain in the final storage pile 94 indefinitely. Further, it should be recognized that the final ground wood chip material 15 may be transported along the belt conveyor 48′ for immediate packaging, and thus not be transported to the final storage pile 94.

As mentioned above, it should be understood that the comminution apparatus 10 described above in connection with the primary grind operation may be used for the secondary grind, but with operation of the dry colorant system 12 closed down.

The above represents presently preferred embodiments of the invention, and those skilled in the art will appreciate that the same or equivalent constructions and processes can be adapted to any of a number of grinding systems presently known or yet developed and the invention is not to be limited by the particular embodiments described above. For example, while a dual auger screw 42, 43 conveyor has been described in connection with the primary grinder and is preferred, a single auger screw or other types of conveyors which would act to blend the dry colorant 11 with the primary ground wood material 13 prior to introduction to the secondary grind operation could be employed and are contemplated by the present invention. Also, any of a number of different known or yet to be developed metering systems which could effectively supply the dry colorant 11 to the primary ground wood material 13 during its conveyance for uniform blending are contemplated and incorporated herein by reference. Also, while hydraulics have been described as the means of driving the augers 42, 43 of the primary grinder 10 and dry colorant metering system 70 coupled by a suitable hydraulic control system, other types of drives such as chain or belt drives, electric motors, pneumatic drives and the like now in existence or yet to be developed could be employed and are incorporated herein by reference, provided they achieve substantially the same result of controlling the relative application of the colorant 11 in relation to the feed of the primary ground wood material 13 for metered application and blending of the dry colorant 11 with the primary ground wood material 13.

It is to be further understood that the term “dry colorant” means a concentrate of the coloring material prior to adding the water or other liquid carrier solution (i.e., non-water solvents, such as alcohol or the like) used in the secondary grind stage to ultimately “color” the finished ground wood material 15. The dry colorant 11 can be in any particulate form in which it will adhere to the wood chips.

It is understood that the disclosed embodiment is representative of a presently preferred form of the invention and that others that accomplish the same function are incorporated herein within the scope of the claims that follow. The term grinder system as used in the claims refers to either grinder 10 as shown in FIG. 1 when the coated primary chips are returned to housing elements 36 or to a combination of grinders 10 and 10′ in the FIG. 9 embodiment when the primary grind is passed on to grinder housing elements 36′ and the water is introduced to tub 36′.

We claim:

1. A method of operating a comminution system having a dry colorant application system, the comminution system being capable of grinding wood material through the use of a hammer mill which is rotatable about an axis and maintained in a housing adjacent one opening in a chamber, said chamber having another opening for introducing the wood material prior to its being ground, the comminution system having a conveyor mechanism for transporting the ground wood material to a desired location, wherein the method of operation comprises:
providing a hopper for maintaining dry colorant and having an opening for dispensing the dry colorant from the container and onto a primary ground wood material of an initial size;
maintaining the hopper adjacent the conveyor mechanism;
filling the hopper with dry colorant and disbursing the dry colorant from the hopper onto the primary ground wood material transferring along the conveyor mechanism;
reintroducing the primary ground wood material to said chamber and arranging a water spigot adjacent said one opening of said chamber for operable connection with a source of fluid and dispensing the fluid into said chamber and wetting the primary ground wood material with dry colorant thereon; and
rotating said hammer mill and further grinding the wetted ground wood material with the hammer mill providing a finish ground material of a lesser size than the primary ground material whereupon the wetted colorant is impregnated within the finish ground material to alter the visual appearance of the primary ground wood material to take on the desired decorative color of the finish ground material.

2. The method of claim 1 further comprising providing a colorant metering device and communicating the colorant metering device with the container and metering the rate of dispensing dry colorant onto the primary ground wood material.

3. The method of claim 1 further comprising providing a water metering device and communicating the water metering device with the spigot to meter the rate of water dispensed into the chamber.

4. The method of claim 1 further comprising providing a control system operably communicating with said chamber and said spigot allowing an operator to control the dispensing rate of the water and the dry colorant onto the primary ground material.

5. The method of claim 2 further comprising providing a central processing unit and operably connecting said central processing unit to said colorant metering device to regulate the rate at which dry colorant is dispensed onto the primary ground wood material.

6. The method of claim 5 including communicating said central processing unit with said chamber to facilitate regulating the rate at which dry colorant is dispensed.

7. The method of claim 2 further comprising providing a central processing unit and operably communicating said central processing unit with said water metering device to regulate the rate at which water is dispensed into the chamber.

8. The method of claim 7 including communicating said central processing unit with said chamber to facilitate regulating the rate at which water is dispensed.

9. A method for grinding and coloring ground wood material utilizing comminution apparatus having at least one wood accommodating chamber with chip grinder elements, comprising:
grinding wood material to provide primary ground wood material of an initial size;
conveying said primary ground wood material along a path;
dispensing dry colorant substantially uniformly onto said primary ground wood material as it is being conveyed;
transferring said primary ground wood material with said dry colorant coated thereon into said chamber of the comminution apparatus;
wetting the coated primary ground wood material in said chamber; and
at the same time, further grinding the wetted and coated primary ground wood material to produce a decoratively colored finish ground wood material of lesser finished size than the initial primary ground wood material.

10. The method of claim 9 further comprising the step of utilizing water in said wetting step and metering the rate of dispensation of water onto the primary ground wood material.

11. The method of claim 9 further comprising the step of metering the rate of dispensation of dry colorant onto the primary ground wood material.

12. The method of claim 9 further comprising the step of controlling the rate at which said primary ground wood material is ground.

13. The method of claim 12 further comprising the step of metering the dispensation of water onto said primary ground wood material in proportion to the rate at which the primary wood material is being ground.

14. A method of constructing a multiple step wood grinding and chip colorant system comprising:
a. providing a grinder system having primary chipping and secondary chip size reducing capability and incorporating housing structure for rotatable chipper elements including an exit conveyor mechanism;
b. providing a hopper for dry colorant located to dispense dry colorant to wood chips exiting said grinder system on said exit conveyor mechanism to coat primary ground wood chips with dry colorant;
c. providing a conveying mechanism introducing the coated wood chips to said grinder system; and
d. providing a liquid dispensing mechanism for dispensing a liquid in a controlled stream to said housing structure onto said coated wood chips while said chipper elements reduce said coated wood chips in size in a size reducing operation and thoroughly impregnate them with wetted dry colorant during said reducing operation.

15. The method of claim 14 wherein said grinding system has a first, coarse grinder and a second, reducing grinder, said first grinder being separate from said second grinder and said second grinder incorporating said liquid dispensing mechanism.

16. The method of claim 14 wherein said grinding system comprises a single grinder to which said coated chips are returned, said grinder incorporating said liquid dispensing mechanism.

17. The method of claim 14 further providing a central processing unit in operable communication with said hopper to regulate the rate at which dry colorant is dispensed on said wood chips exiting said grinder system.

18. The method of claim 14 further providing a central processing unit in operable communication with said housing structure to regulate the rate of dispensation of said liquid from said liquid dispensing mechanism.
